(19) United States
(12) Patent Application Publication
(10) Pub. No.: US 2013/0288876 A1
(43) Pub. Date: Oct. 31, 2013

(54) CRYSTALLIZED GLASS

(71) Applicants: Tai Fujisawa, Shiga (JP); Shingo Nakane, Shiga (JP)

(72) Inventors: Tai Fujisawa, Shiga (JP); Shingo Nakane, Shiga (JP)

(21) Appl. No.: 13/976,129

(22) PCT Filed: Dec. 26, 2011
(86) PCT No.: PCT/JP2011/079993

§ 371 Date: Jul. 10, 2013

(30) Foreign Application Priority Data
Dec. 27, 2010 (JP) 2010-289448
Nov. 29, 2011 (JP) 2011-259886

(51) Int. Cl. C03C 4/00; C03C 3/083

(52) U.S. Cl. CPC C03C 4/0028; C03C 3/083
USPC 501/32

(57) ABSTRACT

Provided is crystallized glass, comprising, as a glass composition in terms of mass %, 55 to 73% of SiO₂, 17 to 25% of Al₂O₃, 2 to 5% of Li₂O, 2.5 to 5.5% of TiO₂, 0 to 2.3% of ZrO₂, 0.2 to 0.9% of SnO₂, and 0.005 to 0.09% of V₂O₅, wherein the crystallized glass is substantially free of As₂O₃ and Sb₂O₃.

### TECHNICAL FIELD

The present invention relates to crystallized glass used for a top plate of a cooking device having an induction heating unit (IH), a halogen heater, or the like as a heat source.

### BACKGROUND ART

A top plate used in a cooking device having IH, a halogen heater, or the like as a heat source is required to be hard to be broken (to have high mechanical strength and high thermal shock resistance), to have a good appearance, to be hard to be corroded (to have high chemical resistance), to have a high transmittance of infrared light as a heat ray, and the like. As a material satisfying these characteristics, there is given a low-expansion transparent crystallized glass containing a β-quartz solid solution (Li₂O—Al₂O₃-nSiO₂ (n≧2)) as a main crystal, which is used for a top plate of a cooking device.

The low-expansion transparent crystallized glass is manufactured through a blending step of mixing various raw glass materials in a predetermined ratio, a melting step of melting the raw glass materials at high temperature of 1600 to 1900° C. to form a homogenized fluid, a forming step of forming the fluid into various shapes by various methods, an annealing step of removing strain, and a crystallizing step of precipitating a fine crystal. The crystallizing step includes a nucleus forming step of precipitating a fine crystal to be a nucleus of a crystal and a crystal growing step of growing the crystal.

The low-expansion transparent crystallized glass thus manufactured is generally transparent to visible light. Therefore, when the low-expansion transparent crystallized glass is used as a top plate as it is, an internal structure of a cooking device placed below the top plate is seen directly, which degrades appearance. Therefore, the low-expansion transparent crystallized glass is used with visible light shielded sufficiently by coloring the crystallized glass itself with a coloring agent such as V₂O₅ (see, for example, Patent Literature 1), or by forming a light-shielding film on a surface of the crystallized glass (see, for example, Patent Literature 2).

It is considered that the coloring of glass with a coloring agent such as V₂O₅ is generated or intensified by an interaction between the coloring agent and As₂O₃ and Sb₂O₃ as a fining agent. However, an environmental burden caused by As₂O₃ and Sb₂O₃ is large, and hence the use thereof has been limited in recent years. However, if As₂O₃ and Sb₂O₃ are simply excluded from a conventional glass composition, an efficiency of coloring by a coloring agent tends to decrease. Although the effect of shielding visible light can be enhanced by increasing the amount of a coloring agent, there is a problem, according to this method, in that the infrared light transmittance reduces. As a matter of course, the reduction of the infrared light transmittance deteriorates cooking performance. In addition, the thermal energy of a heat source needs to be increased in order to obtain a desired heating performance. Accordingly, the reduction of the infrared light transmittance is also not preferred from the viewpoint of energy savings.

On the other hand, it is proposed that, for example, SnO₂ or the like is added as a component for enhancing the coloring efficiency of a coloring agent, instead of As₂O₃ and Sb₂O₃ (see, for example, Patent Literature 3). According to this method, a top plate having a small environmental burden and being excellent in infrared light transparency and visible light shielding property can be obtained.

### CITATION LIST

Patent Literature 1: JP 03-9056 B
Patent Literature 2: JP 2003-68435 A
Patent Literature 3: JP 2004-523446 A

### SUMMARY OF INVENTION

### Technical Problem

The crystallized glass disclosed in Patent Literature 3 involves a problem in that a variation in visible light transmitting property becomes large depending on a change in thermal history of glass melting in manufacturing. In addition, the glass involves a problem in that color tone thereof becomes changed with a long-term use.

Therefore, a technical problem to be solved by the present invention is to provide a crystallized glass that has a small variation in visible light transmitting property even when the thermal history of glass melting in manufacturing fluctuates and whose color tone hardly changes with a long-term use.

### Solution to Problem

The present invention provides a crystallized glass, comprising, as a glass composition in terms of mass %, 55 to 73% of SiO₂, 17 to 25% of Al₂O₃, 2 to 5% of Li₂O, 2.5 to 5.5% of TiO₂, 0 to 2.3% of ZrO₂, 0.2 to 0.9% of SnO₂, and 0.005 to 0.09% of V₂O₅, wherein the crystallized glass is substantially free of As₂O₃ and Sb₂O₃.

The crystallized glass of the present invention satisfies the composition range as above and therefore can exert such effects in that the glass has a small variation in visible light transmitting property even when the thermal history of glass melting in manufacturing fluctuates, and the color tone is hard to be changed with a long-term use. Mechanisms for the foregoing are described below.

V ions are present mainly in a trivalent to pentavalent state in the glass, and it is presumed that the coloring of the crystallized glass is generated by tetravalent V ions present in the matrix glass phase. Further, it is known that, when tetravalent V ions are bonded to TiO₂ present in the matrix glass phase, the degree of coloring is further enhanced (visible light transmittance decreases). Thus, the coloring of the crystallized glass is largely influenced by the amounts of tetravalent V ions and TiO₂ in the matrix glass phase.

On the other hand, it is known that the valence of V ion changes due to the presence of Sn (in particular, the oxidation-reduction function of Sn ions). That is, it is considered that a mixed ratio between V₂O₅ and SnO₂ influences the degree of coloring. In the present invention, the content ranges of V₂O₅ and SnO₂ are set to the above ranges so that the number of Sn ions is excessive with respect to that of V ions. As a result, even when the oxidation state of a part of Sn ions changes due to the thermal history in melting, Sn ions whose oxidation state do not change are present in an excess amount with respect to V ions and hence the amount of tetravalent V ions hardly changes. Accordingly, even when a melting condition changes, the visible light transmitting property becomes hard to be changed.

In addition, when the crystallized glass of the present invention is used in an application involving heating such as a top plate of a cooking device over a long term, the crystallization further proceeds. When the crystallization proceeds, the matrix glass composition changes so that the concentration of tetravalent V ions and TiO₂ that do not contribute to the crystal composition increase relatively in the matrix glass phase. As a result, a bonding state between tetravalent V ions and TiO₂ changes, and the transmittance in the visible light region changes. The crystallized glass of the present invention has also the following feature. TiO₂ is present in an excess amount with respect to tetravalent V ions, and hence the bonding state between tetravalent V ions and TiO₂ is hard to be changed even when the matrix glass composition changes with a long-term use, and the visible light transmittance is hard to be changed.

It should be noted that the environmental burden of As₂O₃ and Sb₂O₃ is large, and hence the use thereof has been limited in recent years. The crystallized glass of the present invention is substantially free of these components, and hence can reduce the environmental burden at the time of the disposal of the crystallized glass. The expression “substantially free of As₂O₃ and Sb₂O₃” in the present invention means that these components are not added intentionally, in other words, may be contained as inevitable impurities, and specifically, means that the content of each of the components is less than 0.1% (in particular, less than 0.01%).

In the crystallized glass of the present invention, the total content of TiO₂+SnO₂ is preferably 2.7 to 6%.

The crystallized glass of the present invention preferably further comprises 0 to 2% of MgO and 0 to 2% of ZnO.

In the crystallized glass of the present invention, the total content of Li₂O+MgO+ZnO is preferably 3 to 6%.

The crystallized glass of the present invention is preferably used for a top plate of a cooking device.

Also, the present invention presents a crystallizable glass, comprising, as a glass composition in terms of mass %, 55 to 73% of SiO₂, 17 to 25% of Al₂O₃, 2 to 5% of Li₂O, 2.5 to 5.5% of TiO₂, 0 to 2.3% of ZrO₂, 0.2 to 0.9% of SnO₂, and 0.005 to 0.09% of V₂O₅, wherein the crystallizable glass is substantially free of As₂O₃ and Sb₂O₃.

### DESCRIPTION OF EMBODIMENTS

Crystallized glass of the present invention comprises, as a glass composition in terms of mass %, 55 to 73% of SiO₂, 17 to 25% of Al₂O₃, 2 to 5% of Li₂O, 2.5 to 5.5% of TiO₂, 0 to 2.3% of ZrO₂, 0.2 to 0.9% of SnO₂, and 0.005 to 0.09% of V₂Oₛ, wherein the crystallized glass is substantially free of As₂O₃ and Sb₂O₃.

The reasons why the composition is restricted as above are described below. Note that in the following descriptions of the contents of the components, “%” refers to “mass %” unless otherwise stated.

SiO₂ is a component that forms a network of glass and constitutes a β-quartz solid solution. The content of SiO₂ is preferably 55 to 73%, 60 to 71%, particularly preferably 63 to 70%. When the content of SiO₂ is too small, the thermal expansion coefficient tends to increase, which makes it difficult to obtain crystallized glass excellent in thermal shock resistance. Further, the chemical resistance tends to decrease. On the other hand, when the content of SiO₂ is too large, the meltability of glass is decreased and the viscosity of molten glass increases, and thus the forming of the glass tends to be difficult.

Al₂O₃ is a component that forms a network of glass and constitutes a β-quartz solid solution. The content of Al₂O₃ is preferably 17 to 25%, 17.5 to 24%, particularly preferably 18 to 22%. When the content of Al₂O₃ is too small, the thermal expansion coefficient tends to increase, which makes it difficult to obtain crystallized glass excellent in thermal shock resistance. Further, the chemical resistance tends to decrease. On the other hand, when the content of Al₂O₃ is too large, the meltability of glass is decreased and the viscosity of glass melt increases, and thus the forming of the glass tends to be difficult. Further, the glass tends to be devitrified due to the precipitation of a mullite crystal, and cracks are liable to occur in the glass from the devitrified portion. Thus, the forming of the glass tends to be difficult.

Li₂O is a component that constitutes a β-quartz solid solution and has a large effect on crystallinity and also decreases the viscosity of glass to enhance the meltability and formability. The content of Li₂O is preferably 2 to 5%, 2.3 to 4.7%, particularly preferably 2.5 to 4.5%. When the content of Li₂O is too small, the glass tends to be devitrified due to the precipitation of a mullite crystal, and cracks are liable to occur in the glass from the devitrified portion. Thus, the forming of the glass tends to be difficult. Further, when the glass is crystallized, a β-quartz solid solution crystal becomes hard to be precipitated, and crystallized glass excellent in thermal shock resistance is difficult to be obtained. Further, the meltability of glass tends to decrease and the viscosity of molten glass tends to increase. Thus, the forming of the glass tends to be difficult. On the other hand, when the content of Li₂O is too large, the crystallinity becomes too strong, so that a coarse crystal is liable to be precipitated in the crystallization step. As a result, a transparent crystallized glass is difficult to be obtained due to cloudiness, or the resultant glass is liable to be broken, and thus the forming thereof tends to be difficult.

TiO₂ is a component that forms crystal nuclei for precipitating a crystal in the crystallization step, and has a function of enhancing coloration of tetravalent V ions. The content of TiO₂ is preferably 2.5 to 5.5%, 2.6 to 5.2%, 2.8 to 5.0%, particularly preferably 3.4 to 4.8%. When the content of TiO₂ is too small, the amount of TiO₂ that remains in a matrix glass phase becomes small. Therefore, TiO₂ is hard to be bonded to tetravalent V ions, so that the efficiency of coloration tends to decrease. On the other hand, when the content of TiO₂ is too large, the glass tends to be devitrified in the process from the melting step to the forming step and becomes liable to be broken, and thus the forming thereof tends to be difficult.

ZrO₂ is a component that forms crystal nuclei for precipitating a crystal in the crystallization step in the similar manner to that of TiO₂. The content of ZrO₂ is preferably 0 to 2.3%, 0 to 2.1%, particularly preferably 0.1 to 1.8%. When the content of ZrO₂ is too large, the glass tends to be devitrified in the process from the melting step to the forming step and becomes liable to be broken, and thus the forming thereof tends to be difficult.

The total content of TiO₂ and ZrO₂ is preferably 3.8 to 6.5%, particularly preferably 4.2 to 6%. When the total content of these components is too large, the glass tends to be devitrified in the process from the melting step to the forming step and becomes liable to be broken, and thus the forming thereof tends to be difficult. On the other hand, when the total content of these components is too small, crystal nuclei are not formed sufficiently. Accordingly, the crystal is liable to become coarse. As a result, a transparent crystallized glass is difficult to be obtained due to cloudiness.

SnO₂ is a component that increases tetravalent V ions as a coloring component to enhance coloration, and also has a fining function. The content of SnO₂ is preferably 0.2 to 0.9%, 0.2 to 0.85%, 0.25 to 0.8%, particularly preferably 0.28 to 0.7%. When the content of SnO₂ is too small, tetravalent V ions are not generated efficiently, and hence a coloring effect is hard to be enhanced. In addition, the visible light transmitting property becomes liable to fluctuate upon changing of melting condition. When the content of SnO₂ is too large, the glass tends to be devitrified in the process from the melting step to the forming step and becomes liable to be broken, and thus the forming thereof tends to be difficult.

The total content of TiO₂ and SnO₂ is preferably 2.7 to 6%, particularly preferably 3 to 5.5%. When the total content of these components is too small, the coloring effect of V ions is hard to be enhanced. On the other hand, when the total content of these components is too large, the glass tends to be devitrified in the process from the melting step to the forming step and becomes liable to be broken, and thus the forming thereof tends to be difficult.

V₂O₅ is a coloring component. The content of V₂O₅ is preferably 0.005 to 0.09%, 0.015 to 0.08%, 0.025 to 0.07%, particularly preferably 0.028 to 0.06%. When the content of V₂O₅ is too small, coloring becomes insufficient, which makes it hard to shield visible light sufficiently. On the other hand, when the content of V₂O₅ is too large, the transmittance of infrared light tends to decrease. Further, a β-quartz solid solution becomes liable to be subjected to crystal transition to a β-spodumene solid solution, which may cause cloudiness.

It should be noted that when the contents of SnO₂ and V₂O₅ satisfy the above ranges, and the value of SnO₂+10V₂O₅ is 0.55% or more, particularly 0.6% or more, the crystallized glass tends to be sufficiently colored and excellent invisible light shielding property.

A ratio (SnO₂/V₂O₅:mass ratio) between the contents of SnO₂ and V₂O₅ is preferably 5.8 or more, particularly preferably 6.5 or more. When the ratio SnO₂/V₂O₅ is too small, the visible light transmitting property becomes liable to fluctuate upon changing of melting condition.

It should be noted that the crystallized glass of the present invention is substantially free of As₂O₃ and Sb₂O₃ because these components are substances that cause an environmental burden.

In addition to the above-mentioned components, the following components can be added to the crystallized glass of the present invention within a range not impairing the required properties.

MgO is a component that dissolves in a β-quartz solid solution crystal in place of Li₂O. MgO has a larger increasing effect on the thermal expansion coefficient than that of Li₂O, and hence the thermal expansion coefficient of the crystallized glass can be adjusted by actively adding MgO. In addition, when MgO dissolves in a β-quartz solid solution crystal, transition from the β-quartz solid solution crystal to a β-spodumene crystal can be suppressed. As a result, the breakage of the crystallized glass caused by a local increase in thermal expansion coefficient due to the precipitation of the β-spodumene crystal can be suppressed. The content of MgO is preferably 0 to 2%, 0 to 1.7%, particularly preferably 0.1 to 1.5%. When the content of MgO is too large, the crystallinity of the glass tends to be so strong that the glass is devitrified. As a result, the glass becomes liable to be broken, which makes the forming of the glass difficult.

ZnO is a component that dissolves in the β-quartz solid solution crystal in the similar manner to that of MgO. The thermal expansion coefficient of the crystallized glass can be adjusted by adding ZnO in the similar manner to that of MgO. In addition, the transition from the β-quartz solid solution crystal to the β-spodumene crystal can be suppressed. Accordingly, the breakage of the crystallized glass caused by a local increase in thermal expansion coefficient due to the precipitation of the β-spodumene crystal can be suppressed. The content of ZnO is preferably 0 to 2%, 0 to 1.7%, particularly preferably 0.1 to 1.5%. When the content of ZnO is too large, the crystallinity tends to become too strong. Therefore, when forming is performed with gradual cooling, the glass is devitrified to be liable to be broken, which is unsuitable for forming, for example, by a float method.

It should be noted that the total content of Li₂O, MgO, and ZnO is preferably 3 to 6%, particularly preferably 3.5 to 5.5%. When the total content of these components is too small, the glass tends to be devitrified due to the precipitation of a mullite crystal, and cracks are liable to occur in the glass from the devitrified portion. Accordingly, the forming of the glass tends to be difficult. In addition, the β-quartz solid solution crystal is hard to be precipitated upon crystallization of the glass, which makes it difficult to obtain crystallized glass excellent in thermal shock resistance. Further, the meltability of glass tends to be decreased and the viscosity of molten glass tends to increase, and hence the forming of the glass tends to be difficult. On the other hand, when the total content of these components is too large, the crystallinity of the glass becomes so strong that a coarse crystal is liable to be precipitated in the crystallization step. As a result, a transparent crystallized glass cannot be obtained due to cloudiness, or the glass becomes liable to be broken and hence the forming thereof tends to be difficult.

P₂O₅ is a component that accelerates the phase separation of glass. As crystal nuclei are likely to be generated in a place where the glass is subjected to phase separation, P₂O₅ has a function of assisting the formation of crystal nuclei. The content of P₂O₅ is preferably 0 to 2%, particularly preferably 0.1 to 1%. When the content of P₂O₅ is too large, the glass is subjected to phase separation in the melting step. Therefore, glass having a desired composition is hard to be obtained, and the resultant glass tends to be opaque.

Na₂O is a component that decreases the viscosity of glass to enhance the meltability and formability of the glass. The content of Na₂O is preferably 0.5% or less, 0.3% or less, particularly preferably 0.2% or less. When the content of Na₂O is too large, the crystal transition from the β-quartz solid solution to the β-spodumene solid solution is accelerated, and hence cloudiness is liable to occur due to coarse crystals. Further, the thermal expansion coefficient tends to increase, which makes it difficult to obtain crystallized glass excellent in thermal shock resistance.

In order to decrease the viscosity of glass to enhance the meltability and formability thereof, K₂O, CaO, SrO, and BaO can be added in the total content of up to 5%. It should be noted that CaO, SrO, and BaO are each a component that cause denitrification when melting glass. Therefore, it is preferable that the total content of these components be 2% or less. Further, CaO has a function of accelerating the crystal transition from the β-quartz solid solution to the β-spodumene solid solution, and hence the crystallized glass should be refrained from the use of CaO as much as possible.

As a fining agent, So₂ and Cl may be added alone or in combination, if required. The total content of these components is preferably 0.5% or less. In particular, Cl is excellent in fining property and has an enhancing effect on coloration of V ions.

Colored transition metal elements except Ti, Zr, and V (for example, Cr, Mn, Fe, Co, Ni, Cu, Mo, and Cd) may absorb infrared light or may cause the loss of a reduction ability of Sn ions (the colored transition metal elements react with Sn ions to inhibit a reaction between V ions and Sn ions). In addition, the colored transition metal elements are bonded to Sn ions to exert enhancing effects on coloration of each colored transition metal ion. Therefore, it is preferred to avoid containing these elements as much as possible. Specifically, the content of each of these components is limited to preferably 1000 ppm or less, 500 ppm or less, particularly preferably 300 ppm or less.

Crystallizable glass as a material for the crystallized glass of the present invention comprises, as a glass composition in terms of mass %, 55 to 73% of SiO₂, 17 to 25% of Al₂O₃, 2 to 5% of Li₂O, 2.5 to 5.5% of TiO₂, 0 to 2.3% of ZrO₂, 0.2 to 0.9% of SnO₂, and 0.005 to 0.09% of V₂O₅, wherein the crystallizable glass is substantially free of As₂O₃ and Sb₂O₃.

Those described in the foregoing for the crystallized glass are applicable to, for example, the reasons why the composition is thus restricted and preferred composition ranges, and any other components that can be added.

The crystallized glass of the present invention can be manufactured as follows.

First, various raw glass materials are blended so as to obtain the above-mentioned glass composition. Next, the blended raw glass materials are melted at a temperature of, for example, 1600 to 1900° C. and then formed to obtain a crystallizable glass. As a forming method, various forming methods such as a blow method, a press method, a roll-out method, and a float method are applicable. After the crystallizable glass is annealed, crystal nuclei are formed at, for example, 700 to 800° C. Then, β-quartz solid solution crystals are grown at 800 to 900° C. to obtain the crystallized glass.

The crystallized glass thus manufactured may be subjected to post-processing such as cutting, polishing, bending, and reheat pressing, and a surface thereof may be subjected to painting, film coating, or the like.

The crystallized glass of the present invention has a transmittance, at a thickness of 3 mm, at a wavelength of 700 nm, of preferably 35% or less, particularly preferably 30% or less. This can shield the internal structure of a cooking device sufficiently. On the other hand, in a case where a luminescent display device such as an LED is placed below a crystallized glass plate to indicate a temperature, a thermal power, or the like through the crystallized glass plate, the crystallized glass has a transmittance, at a thickness of 3 mm, at a wavelength of 700 nm, of preferably 5% or more, 10% or more, particularly preferably 15% or more. Thus, when the crystallized glass is used for a top plate of a cooking device having IH or the like, indications by the luminescent display device are sufficiently visible through the crystallized glass plate.

Further, the crystallized glass of the present invention has a transmittance, at a thickness of 3 mm, at a wavelength of 1150 nm, of preferably 85% or more, more preferably 86% or more, in order to transmit a heat ray (infrared light) efficiently.

It is preferred that the visible light transmittance be hard to be changed, even when the crystallized glass of the present invention is used for an application involving heating such as a top plate of a cooking device for a long term. Specifically, for the crystallized glass of the present invention, a change ratio of an absorbance at a wavelength of 700 nm, after heat treat treatment at 900° C. for 50 hours as an acceleration test, is preferably 10% or less, 8% or less, particularly preferably 5% or less. The absorbance change ratio is calculated as follows.

Absorbance=−log₁₀(transmittance(%)/100)

Absorbance change ratio=(absorbance after heat treatment−absorbance before heat treatment)/absorbance before heat treatment×100(%)

The thermal expansion coefficient of the crystallized glass of the present invention in a temperature range of 30 to 750° C. is preferably −10 to 30×10⁻⁷/° C., particularly preferably −10 to 20×10⁻⁷/° C. When the thermal expansion coefficient is within this range, the crystallized glass excellent in thermal shock resistance is obtained. In the present invention, the thermal expansion coefficient refers to a value measured by a dilatometer.

### EXAMPLES

Next, the present invention is described in detail by way of examples. However, the present invention is not limited to these examples.

Tables 1 to 4 show examples (Nos. 1 to 11, 16, and 17) of the present invention and comparative examples (Nos. 12 to 15).

TABLE 1

| [Mass %] | | | No. 1 | No. 2 | No. 3 | No. 4 | No. 5 |
|---|---|---|---|---|---|---|---|
| SiO₂ | | | 67.565 | 68.37 | 67.775 | 68.077 | 68.18 |
| Al₂O₃ | | | 21.0 | 20.2 | 19.8 | 20.5 | 20.6 |
| Li₂O | | | 4.3 | 3.8 | 3.9 | 4.1 | 3.7 |
| MgO | | | | 0.5 | 0.8 | 0.2 | 1.2 |
| ZnO | | | 1.1 | 0.8 | 0.2 | 0.4 | |
| TiO₂ | | | 4.2 | 4.8 | 3.8 | 4.0 | 4.5 |
| ZrO₂ | | | 0.8 | | 1.5 | 0.5 | 0.2 |
| P₂O₅ | | | | 0.3 | 0.2 | 1.0 | 0.5 |
| Na₂O | | | 0.2 | 0.5 | 0.3 | | 0.1 |
| K₂O | | | 0.5 | 0.3 | 0.2 | 0.5 | 0.3 |
| CaO | | | | | | 0.1 | |
| BaO | | | | | 1.0 | | |
| SnO₂ | | | 0.3 | 0.4 | 0.5 | 0.6 | 0.7 |
| V₂O₅ | | | 0.035 | 0.030 | 0.025 | 0.023 | 0.020 |
| Li + Mg + Zn | | | 5.4 | 5.1 | 4.9 | 4.7 | 4.9 |
| Ti + Sn | | | 4.5 | 5.2 | 4.3 | 4.6 | 5.2 |
| Transmittance | Melting | 700 nm | 21.9 | 20.1 | 18.0 | 18.5 | 18.2 |
| (%) | condition 1 | 1150 nm | 87.8 | 86.3 | 85.7 | 85.4 | 86.2 |
| | Melting | 700 nm | 20.3 | 18.5 | 17.3 | 17.4 | 15.9 |
| | condition 2 | 1150 nm | 87.5 | 85.5 | 85.4 | 84.6 | 85.5 |
| | Melting | 700 nm | 21.7 | 19.6 | 18.4 | 17.6 | 17.3 |
| | condition 3 | 1150 nm | 87.8 | 86.6 | 86.1 | 84.2 | 85.4 |

| Absorbance variation (%) | | 5 | 5 | 4 | 4 | 8 |
|---|---|---|---|---|---|---|
| (λ = 700 nm) | | | | | | |
| 700 nm | Before heat | 21.9 | 20.1 | 18.0 | 18.5 | 18.2 |
| | treatment | | | | | |
| | After heat | 19.6 | 17.5 | 15.7 | 16.2 | 15.5 |
| | treatment | | | | | |
| 1150 nm | Before heat | 87.8 | 86.3 | 85.7 | 85.4 | 86.2 |
| | treatment | | | | | |
| | After heat | 86.0 | 84.4 | 84.5 | 83.8 | 84.3 |
| | treatment | | | | | |

| | | | | | |
|---|---|---|---|---|---|
| Absorbance change ratio (%) | 7 | 9 | 8 | 8 | 9 |
| (λ = 700 nm) | | | | | |
| Fining performance | B | B | A | A | A |
| Devitrification resistance | ∘ | ∘ | ∘ | ∘ | ∘ |

TABLE 2

| [Mass %] | | | No. 6 | No. 7 | No. 8 | No. 9 | No. 10 |
|---|---|---|---|---|---|---|---|
| SiO₂ | | | 67.57 | 68.765 | 68.06 | 66.36 | 65.78 |
| Al₂O₃ | | | 20.0 | 20.3 | 20.5 | 22.0 | 21.2 |
| Li₂O | | | 4.1 | 4.3 | 4.2 | 3.7 | 3.2 |
| MgO | | | 0.5 | 0.7 | 0.5 | 0.4 | 1.0 |
| ZnO | | | 0.3 | 0.2 | 0.3 | 0.3 | 1.2 |
| TiO₂ | | | 5.0 | 4.2 | 3.0 | 2.8 | 3.9 |
| ZrO₂ | | | 0.3 | 0.6 | 1.5 | 2.0 | 1.2 |
| P₂O₅ | | | 0.5 | | 1.2 | 1.0 | — |
| Na₂O | | | 0.8 | 0.2 | 0.3 | 0.7 | 0.3 |
| K₂O | | | 0.5 | 0.3 | | 0.4 | 0.2 |
| CaO | | | | 0.1 | | | |
| BaO | | | | | | | 1.3 |
| SnO₂ | | | 0.50 | 0.30 | 0.40 | 0.30 | 0.70 |
| V₂O₅ | | | 0.03 | 0.035 | 0.04 | 0.04 | 0.02 |
| Li + Mg + Zn | | | 4.9 | 5.2 | 5.0 | 4.4 | 5.4 |
| Ti + Sn | | | 5.5 | 4.5 | 3.4 | 3.1 | 4.6 |
| Transmittance | Melting | 700 nm | 15.0 | 21.8 | 17.9 | 16.1 | 16.2 |
| (%) | condition 1 | 1150 nm | 87.3 | 87.6 | 84.4 | 85.9 | 85.7 |
| | Melting | 700 nm | 14.6 | 20.5 | 17.7 | 15.9 | 15.5 |
| | condition 2 | 1150 nm | 87.2 | 87.0 | 84.1 | 85.7 | 85.0 |
| | Melting | 700 nm | 15.3 | 22.0 | 18.2 | 16.5 | 16.5 |
| | condition 3 | 1150 nm | 87.7 | 87.9 | 84.6 | 86.0 | 85.7 |

| Absorbance variation (%) | | 3 | 4 | 2 | 2 | 3 |
|---|---|---|---|---|---|---|
| (λ = 700 nm) | | | | | | |
| 700 nm | Before heat | 15.0 | 21.8 | 17.9 | 16.1 | 16.2 |
| | treatment | | | | | |
| | After heat | 13.5 | 18.6 | 16.0 | 14.3 | 14.2 |
| | treatment | | | | | |
| 1150 nm | Before heat | 87.3 | 87.6 | 84.4 | 85.9 | 85.7 |
| | treatment | | | | | |
| | After heat | 86.7 | 86.2 | 83.6 | 84.7 | 83.8 |
| | treatment | | | | | |

| | | | | | |
|---|---|---|---|---|---|
| Absorbance change ratio (%) | 6 | 10 | 7 | 7 | 7 |
| (λ = 700 nm) | | | | | |
| Fining performance | A | B | B | B | A |
| Devitrification resistance | ∘ | ∘ | ∘ | ∘ | ∘ |

TABLE 3

| | | | | No. | | No. | |
|---|---|---|---|---|---|---|---|
| [Mass %] | | | No. 11 | 12 | No. 13 | 14 | No. 15 |
| SiO₂ | | | 68.765 | 67.08 | 68.92 | 67.19 | 68.03 |
| Al₂O₃ | | | 20.3 | 19.7 | 20.3 | 20.8 | 20.5 |
| Li₂O | | | 4.3 | 4.2 | 4.3 | 3.5 | 4.0 |
| MgO | | | 0.7 | 0.5 | 0.7 | 0.3 | 1.2 |
| ZnO | | | 0.2 | 0.6 | 0.2 | 1.0 | 0.3 |
| TiO₂ | | | 4.2 | 3.8 | 4.2 | 4.4 | 4.9 |
| ZrO₂ | | | 0.6 | 1.1 | 0.6 | 0.2 | |
| P₂O₅ | | | | 1.2 | | | |
| Na₂O | | | 0.2 | 0.4 | 0.2 | 0.4 | 0.5 |
| K₂O | | | 0.3 | 0.2 | 0.3 | 0.3 | 0.2 |
| CaO | | | 0.1 | | 0.1 | | |
| BaO | | | | | | 1.5 | |
| SnO₂ | | | 0.30 | 1.2 | 0.1 | 0.4 | 0.25 |
| V₂O₅ | | | 0.035 | 0.02 | 0.08 | 0.001 | 0.12 |
| Fe₂O₃ | | | 0.06 | | | | |
| Li + Mg + Zn | | | 5.2 | 5.3 | 5.2 | 4.8 | 5.5 |
| Ti + Sn | | | 4.5 | 5.0 | 4.3 | 4.8 | 5.15 |
| Transmittance | Melting | 700 nm | 17.5 | — | 25.6 | — | 22.8 |
| (%) | condition 1 | 1150 nm | 82.7 | — | 83.5 | — | 82.2 |
| | Melting | 700 nm | 16.4 | 18.4 | 22.4 | 83.5 | 21.6 |
| | condition 2 | 1150 nm | 82.3 | 83.8 | 83.1 | 88.7 | 80.3 |
| | Melting | 700 nm | 17.1 | — | 27.8 | — | 25.4 |
| | condition 3 | 1150 nm | 82.5 | — | 84.0 | — | 81.8 |

| Absorbance variation (%) | | 4 | — | 14 | — | 11 |
|---|---|---|---|---|---|---|
| (λ = 700 nm) | | | | | | |
| 700 nm | Before heat | 17.5 | — | 25.6 | — | 22.8 |
| | treatment | | | | | |
| | After heat | 15.7 | — | 21.5 | — | 17.6 |
| | treatment | | | | | |
| 1150 nm | Before heat | 82.7 | — | 83.5 | — | 82.2 |
| | treatment | | | | | |
| | After heat | 81.9 | — | 82.1 | — | 79.4 |
| | treatment | | | | | |

| | | | | | |
|---|---|---|---|---|---|
| Absorbance change ratio (%) | 6 | — | 13 | — | 17 |
| (λ = 700 nm) | | | | | |
| Fining performance | B | A | D | B | A |
| Devitrification resistance | ∘ | x | ∘ | ∘ | ∘ |

TABLE 4

| [Mass %] | | | No. 16 | No. 17 |
|---|---|---|---|---|
| SiO₂ | | | 68.765 | 66.75 |
| Al₂O₃ | | | 20.3 | 21.0 |
| Li₂O | | | 4.3 | 4.0 |
| MgO | | | 0.7 | 0.5 |
| ZnO | | | 0.2 | 0.8 |
| TiO₂ | | | 4.2 | 3.8 |
| ZrO₂ | | | 0.6 | 1.5 |
| P₂O₅ | | | — | 0.5 |
| Na₂O | | | 0.2 | 0.3 |
| K₂O | | | 0.3 | 0.5 |
| CaO | | | 0.1 | — |
| BaO | | | — | — |
| SnO₂ | | | 0.30 | 0.28 |
| V₂O₅ | | | 0.035 | 0.07 |
| Cl | | | 0.06 | — |
| Li + Mg + Zn | | | 5.2 | 5.3 |
| Ti + Sn | | | 4.5 | 4.08 |
| Transmittance | Melting | 700 nm | 16.7 | 21.8 |
| (%) | condition 1 | 1150 nm | 82.2 | 81.4 |
| | Melting | 700 nm | 15.9 | 19.5 |
| | condition 2 | 1150 nm | 81.8 | 80.6 |
| | Melting | 700 nm | 16.5 | 21.1 |
| | condition 3 | 1150 nm | 82.0 | 81.4 |

| Absorbance variation (%) | | 3 | 7 |
|---|---|---|---|
| (λ = 700 nm) | | | |
| 700 nm | Before heat | 16.7 | 21.8 |
| | treatment | | |
| | After heat | 15.2 | 19.8 |
| | treatment | | |
| 1150 nm | Before heat | 82.2 | 81.4 |
| | treatment | | |
| | After heat | 81.5 | 80.3 |
| | treatment | | |

| | | |
|---|---|---|
| Absorbance change ratio (%) | 5 | 6 |
| (λ = 700 nm) | | |
| Fining performance | A | B |
| Devitrification resistance | ◯ | ◯ |

First, raw glass materials were blended so as to obtain the compositions shown in Tables 1 to 4. The blended raw glass materials were loaded into a platinum crucible and melted under the following melting conditions 1 to 3.

Melting condition 1: Melting at 1600° C. for 24 hours

Melting condition 2: Melting at 1600° C. for 20 hours, followed by melting at 1700° C. for 4 hours

Melting condition 3: Melting at 1500° C. for 20 hours, followed by melting at 1600° C. for 4 hours

Two spacers each with a thickness of 5 mm were placed on a carbon sheet, and molten glass was poured between the spacers and formed into a sheet shape having a uniform thickness with a roller. The resultant sheet shaped sample was loaded into an electric furnace kept at 700° C. and held for 30 minutes. After that, the sample was cooled (annealed) to room temperature in the furnace over 10 hours or more.

Then, the cooled sample was heated in the electric furnace to obtain crystallized glass. The heating profile thereof was set as follows: nucleus formation step was performed at 770° C. for 3 hours, and crystal growth step was performed at 880° C. for 1 hour.

The resultant crystallized glass was evaluated for its transmittance invisible and infrared regions, fining performance, and denitrification resistance.

Each crystallized glass was processed into a sample having a thickness of 3 mm with both mirror polished surfaces, and the transmittance thereof was measured at 700 nm and 1150 nm, using a spectrophotometer (produced by Jasco Corporation, V-760). The measurement conditions were as follows: a measurement range of 1500 to 380 nm and a scan speed of 200 nm/min. Further, the samples subjected to heat treatment (acceleration test) at 900° C. for 50 hours were also measured for transmittance in the same manner.

In addition, an absorbance was calculated from the transmittance of each sample in accordance with the calculation equation described in the foregoing, and an absorbance variation at a wavelength of 700 nm was determined for each of the crystallized glasses obtained under the melting conditions 1 to 3. Further, a change ratio between the absorbances at a wavelength of 700 nm before and after the acceleration test was determined for the crystallized glass obtained under the melting condition 1. It should be noted that the absorbance variation was determined in accordance with the following calculation equation.

Absorbance variation=(absorbanceₘₐₓ−absorbanceₘᵢₙ)/absorbanceₘᵢₙ×100(%)

(Here, the maximum and minimum of the absorbances at a wavelength of 700 nm measured for the crystallized glasses obtained under the melting conditions 1 to 3 were referred to as “absorbanceₘₐₓ” and “absorbanceₘᵢₙ,” respectively.)

An evaluation for fining performance was performed as described below. The number of bubbles per 100 g of a sample was calculated, and the sample was evaluated as “A” when the number of bubbles per 100 g of the sample was 0, as “B” when the number of bubbles was more than 0 and less than 2, as “C” when the number of bubbles was 2 to less than 5, as “D” when the number of bubbles was 5 to less than 10, or as “E” when the number of bubbles was 10 or more. It should be noted that a smaller bubble number means that the number of bubbles remaining in the glass is smaller and hence the glass is more excellent in fining performance.

The devitrification resistance was evaluated by placing each sample on a platinum foil in an electric furnace set to 1350° C. and keeping the sample for 24 hours, and determining whether or not devitrification occurred. When the devitrification was not observed, the evaluation was made as “∘”, and when the devitrification was observed, the evaluation was made as “x”.

As is apparent from Tables 1 to 4, each of the crystallized glasses Nos. 1 to 11, 16, and 17 as examples shows a small change in transmittance (absorbance) property for visible light even when a melting condition is changed and hence can sufficiently shield light in the visible region, and also has a high infrared light transmittance. It is also understood from the tables that each of the crystallized glasses Nos. 1 to 11, 16, and 17 shows a small change in transmittance in the visible region even in the acceleration test estimating long-term use.

On the other hand, the crystallized glass No. 12 as a comparative example was poor in devitrification resistance. In addition, each of the crystallized glasses Nos. 13 and 15 showed a large change in transmitting property for visible light due to a difference in melting condition, and a large change between transmittance properties for visible light before and after the acceleration test. The transmittance at 700 nm of the crystallized glass No. 14 was 83.5%, which was an extremely large value, because the content of V₂O₅ as a coloring agent was too small.

### INDUSTRIAL APPLICABILITY

The crystallized glass of the present invention is suitable as a top plate of a cooking device using, for example, IH, a halogen heater, a heating wire, or gas.

1. A crystallized glass, comprising, as a glass composition in terms of mass %, 55 to 73% of SiO₂, 17 to 25% of Al₂O₃, 2 to 5% of Li₂O, 2.5 to 5.5% of TiO₂, 0 to 2.3% of ZrO₂, 0.2 to 0.9% of SnO₂, and 0.005 to 0.09% of V₂O₅, wherein the crystallized is substantially free of As₂O₃ and Sb₂O₃.

2. The crystallized glass according to claim 1, wherein the total content of TiO₂+SnO₂ is 2.7 to 6%.

3. The crystallized glass according to claim 1, further comprising 0 to 2% of MgO and 0 to 2% of ZnO.

4. The crystallized glass according to claim 3, wherein the total content of Li₂O+MgO+ZnO is 3 to 6%.

5. The crystallized glass according to claim 1, wherein the crystallized glass is used for a top plate of a cooking device.

6. A crystallizable glass, comprising, as a glass composition in terms of mass %, 55 to 73% of SiO₂, 17 to 25% of Al₂O₃, 2 to 5% of Li₂O, 2.5 to 5.5% of TiO₂, 0 to 2.3% of ZrO₂, 0.2 to 0.85% of SnO₂, and 0.005 to 0.09% of V₂O₅, wherein the crystallizable glass is substantially free of As₂O₃ and Sb₂O₃.
